(19) United States
(12) Patent Application Publication
(10) Pub. No.: US 2013/0226322 A1
(43) Pub. Date: Aug. 29, 2013

(54) AUDIO SCENE APPARATUS

(71) Applicant: Juha Petteri Ojanpera, Nokia (FI)

(72) Inventor: Juha Petteri Ojanpera, Nokia (FI)

(73) Assignee: NOKIA CORPORATION, Espoo (FI)

(21) Appl. No.: 13/820,019

(22) PCT Filed: Aug. 31, 2010
(86) PCT No.: PCT/IB2010/053907

§ 371 Date: May 15, 2013

(51) Int. Cl. G06F 3/16

(52) U.S. Cl. CPC G06F 3/16
USPC 700/94

(57) ABSTRACT

Apparatus comprising at least one processor and at least one memory including computer code, the at least one memory and the computer code configured to with the at least one processor cause the apparatus to at least perform: determining whether a further apparatus is capturing an audio signal neighbouring the apparatus; determining a capture characteristic based on whether the further apparatus is capturing an audio signal neighbouring the apparatus; and capturing the audio signal based on the capture characteristic.

### FIELD OF THE APPLICATION

The present application relates to apparatus for the processing of audio and additionally video signals. The invention further relates to, but is not limited to, apparatus for processing audio and additionally video signals from mobile devices.

### BACKGROUND OF THE APPLICATION

Viewing recorded or streamed audio-video or audio content is well known. Commercial broadcasters covering an event often have more than one recording device (video-camera/microphone) and a programme director will select a ‘mix’ where an output from a recording device or combination of recording devices is selected for transmission.

Multiple ‘feeds’ may be found in sharing services for video and audio signals (such as those employed by YouTube). Such systems, which are known and are widely used to share user generated content recorded and uploaded or up-streamed to a server and then downloaded or down-streamed to a viewing/listening user. Such systems rely on users recording and uploading or up-streaming a recording of an event using the recording facilities at hand to the user. This may typically be in the form of the camera and microphone arrangement of a mobile device such as a mobile phone.

Often the event is attended and recorded from more than one position by different recording users at the same time. The viewing/listening end user may then select one of the up-streamed or uploaded data to view or listen.

Where there is multiple user generated content for the same event it can be possible to generate a “three dimensional” rendering of the event by combining various different recordings from different users or improve upon user generated content from a single source, for example reducing background noise by mixing different users content to attempt to overcome local interference, or uploading errors.

There can be a problem in multiple recording systems where the recording devices are in close proximity and the same audio scene is recorded multiple times. This is generally due to recording devices not being aware of other devices recording the same audio scene. This can cause recording redundancy and inefficiencies to the overall end-to-end system in terms of required storage space at the device and server, battery life of devices, network bandwidth utilisation and other resources as multiple devices may be recording and encoding the same scene from approximately the same position and the same content recorded and uploaded to a central server multiple times.

In addition to this from the server's point of view the discovery of an audio scene from the uploaded information can be problematic as the typical accuracy of a positioning system, for example a GPS positioning system can be between 1-15 metres leading to problems in localising each recording source using the GPS information determined at the selected listening point. Furthermore positioning systems such as GPS location positioning systems furthermore have problems with accuracy for “indoor” recordings and thus cannot provide a suitable localisation estimate.

Aspects of this application thus provide an audio scene capturing process whereby multiple devices can be present and recording the audio scene and whereby the server can further discover or detect audio scenes from the uploaded data.

### SUMMARY OF THE APPLICATION

There is provided according to the application an apparatus comprising at least one processor and at least one memory including computer code, the at least one memory and the computer code configured to with the at least one processor cause the apparatus to at least perform: determining whether a further apparatus is capturing an audio signal neighbouring the apparatus; determining a capture characteristic based on whether the further apparatus is capturing an audio signal neighbouring the apparatus; and capturing the audio signal based on the capture characteristic.

Determining whether a further apparatus is capturing an audio signal neighbouring the apparatus may further cause the apparatus to perform determining whether an awareness indicator has been received from the further apparatus.

The awareness indicator may comprise at least one of: a further apparatus identifier value; a further apparatus capture characteristic value; and a defined distance value.

Determining whether a further apparatus is capturing an audio signal neighbouring the apparatus may further cause the apparatus to perform: determining the distance between the apparatus and the further apparatus; and determining the further apparatus is neighbouring the apparatus when the distance is less than a defined value.

The capture characteristic may comprise at least one of: capture encoding algorithm; capture encoding rate; and capture frequency response.

The apparatus may further be configured to perform: generating an awareness indicator comprising at least one of: an identifier indicator of the apparatus; an identifier indicator of the further apparatus; an indicator of the capture characteristic of the apparatus; and a defined distance value for the apparatus.

The apparatus may further be configured to perform: outputting at least the captured audio signal on a first communications channel; and outputting the awareness indicator on a second communications channel.

The apparatus may be further configured to perform outputting the awareness indicator on the first communications channel.

The first communications channel may comprise a communications data channel.

The second communications channel may comprise at least one of: a communications control channel; a communications broadcast channel; and a Bluetooth communications channel.

According to a second aspect of the application there is provided an apparatus comprising at least one processor and at least one memory including computer code, the at least one memory and the computer code configured to with the at least one processor cause the apparatus to at least perform: receiving at least one captured audio signal, each captured audio signal associated with a capture apparatus, wherein each captured audio signal comprises an indicator indicating whether a neighbouring capture apparatus was capturing the audio signal prior to the capture apparatus; and selecting at least one of the at least one captured audio signal.

The apparatus may be further caused to perform: receiving an audio signal request from a first position; and wherein selecting the at least one of the at least one captured audio signal may further cause the apparatus to perform selecting the at least one of the at least one captured audio signal associated with the capture apparatus closest to the first position where the capture apparatus was capturing the audio signal prior to any other capture apparatus.

Selecting the at least one of the at least one captured audio signal associated with the capture apparatus closest to the first position where the capture apparatus was capturing the audio signal prior to any other capture apparatus may cause the apparatus to perform: determining the capture apparatus closest to the first position; determining the indicator indicates a neighbouring capture apparatus was capturing the audio signal prior to the capture apparatus; and selecting the neighbouring capture apparatus.

According to a third aspect of the application there is provided a method comprising: determining whether a further apparatus is capturing an audio signal neighbouring the apparatus; determining a capture characteristic based on whether the further apparatus is capturing an audio signal neighbouring the apparatus; and capturing the audio signal based on the capture characteristic.

Determining whether a further apparatus is capturing an audio signal neighbouring the apparatus may further comprise determining whether an awareness indicator has been received from the further apparatus.

The awareness indicator may comprise at least one of: a further apparatus identifier value; a further apparatus capture characteristic value; and a defined distance value.

Determining whether a further apparatus is capturing an audio signal neighbouring the apparatus may further comprise: determining the distance between the apparatus and the further apparatus; and determining the further apparatus is neighbouring the apparatus when the distance is less than a defined value.

The capture characteristic may comprise at least one of: capture encoding algorithm; capture encoding rate; and capture frequency response.

The method may further comprise generating an awareness indicator comprising at least one of: an identifier indicator of the apparatus; an identifier indicator of the further apparatus; an indicator of the capture characteristic of the apparatus; and a defined distance value for the apparatus.

The method may further comprise: outputting at least the captured audio signal on a first communications channel; and outputting the awareness indicator on a second communications channel.

The method may further comprise outputting the awareness indicator on the first communications channel.

The first communications channel may comprise a communications data channel.

The second communications channel may comprise at least one of: a communications control channel; a communications broadcast channel; and a Bluetooth communications channel.

According to a fourth aspect of the application there is provided a method comprising: receiving at least one captured audio signal, each captured audio signal associated with a capture apparatus, wherein each captured audio signal comprises an indicator indicating whether a neighbouring capture apparatus was capturing the audio signal prior to the capture apparatus; and selecting at least one of the at least one captured audio signal.

The method may further comprise receiving an audio signal request from a first position; and wherein selecting the at least one of the at least one captured audio signal may further comprise selecting the at least one of the at least one captured audio signal associated with the capture apparatus closest to the first position where the capture apparatus was capturing the audio signal prior to any other capture apparatus.

Selecting the at least one of the at least one captured audio signal associated with the capture apparatus closest to the first position where the capture apparatus was capturing the audio signal prior to any other capture apparatus may comprise: determining the capture apparatus closest to the first position; determining the indicator indicates a neighbouring capture apparatus was capturing the audio signal prior to the capture apparatus; and selecting the neighbouring capture apparatus.

There is provided according to a fifth aspect an apparatus comprising: an awareness determiner configured to determine whether a further apparatus is capturing an audio signal neighbouring the apparatus; a capture controller configured to determine a capture characteristic based on whether the further apparatus is capturing an audio signal neighbouring the apparatus; and a recorder configured to capture the audio signal based on the capture characteristic.

The awareness determiner may further comprise an awareness indicator determiner configured to determine an awareness indicator has been received from the further apparatus.

The awareness indicator may comprise at least one of: a further apparatus identifier value; a further apparatus capture characteristic value; and a defined distance value.

The awareness determiner may further comprise: a distance determiner configured to determine the distance between the apparatus and the further apparatus; and awareness distance comparator configured to determine the further apparatus is neighbouring the apparatus when the distance is less than a defined value.

The capture characteristic may comprise at least one of: capture encoding algorithm; capture encoding rate; and capture frequency response.

The apparatus may further comprise an awareness generator configured to generate an awareness indicator comprising at least one of: an identifier indicator of the apparatus; an identifier indicator of the further apparatus; an indicator of the capture characteristic of the apparatus; and a defined distance value for the apparatus.

The apparatus may further comprise a transmitter configured to output at least the captured audio signal on a first communications channel; and output the awareness indicator on a second communications channel.

The transmitter may further be configured to perform output the awareness indicator on the first communications channel.

The first communications channel may comprise a communications data channel.

The second communications channel may comprise at least one of: a communications control channel; a communications broadcast channel; and a Bluetooth communications channel.

According to a sixth aspect of the application there is provided an apparatus comprising: an input configured to receive at least one captured audio signal, each captured audio signal associated with a capture apparatus, wherein each captured audio signal comprises an indicator indicating whether a neighbouring capture apparatus was capturing the audio signal prior to the capture apparatus; and a selector configured to select at least one of the at least one captured audio signal.

The apparatus may further comprise an input configured to receive an audio signal request from a first position; and wherein the selector is configured to select the at least one of the at least one captured audio signal associated with the capture apparatus closest to the first position where the capture apparatus was capturing the audio signal prior to any other capture apparatus.

The selector may comprise: an apparatus determiner configured to determine the capture apparatus closest to the first position; an awareness determiner configured to determine the indicator indicates a neighbouring capture apparatus was capturing the audio signal prior to the capture apparatus; and a primary apparatus selector configured to select the neighbouring capture apparatus.

There is provided according to a seventh aspect an apparatus comprising: determiner means for determining whether a further apparatus is capturing an audio signal neighbouring the apparatus; controller means for determine a capture characteristic based on whether the further apparatus is capturing an audio signal neighbouring the apparatus; and recording means for capturing the audio signal based on the capture characteristic.

The determiner means may further comprise indicator determiner means for determining an awareness indicator has been received from the further apparatus.

The awareness indicator may comprise at least one of: a further apparatus identifier value; a further apparatus capture characteristic value; and a defined distance value.

The determiner may further comprise: distance determiner means for determining the distance between the apparatus and the further apparatus; and comparator means for determining the further apparatus is neighbouring the apparatus when the distance is less than a defined value.

The capture characteristic may comprise at least one of: capture encoding algorithm; capture encoding rate; and capture frequency response.

The apparatus may further comprise generator means for generating an awareness indicator comprising at least one of: an identifier indicator of the apparatus; an identifier indicator of the further apparatus; an indicator of the capture characteristic of the apparatus; and a defined distance value for the apparatus.

The apparatus may further comprise transmitter means for outputting at least the captured audio signal on a first communications channel; and outputting the awareness indicator on a second communications channel.

The transmitter means may further output the awareness indicator on the first communications channel.

The first communications channel may comprise a communications data channel.

The second communications channel may comprise at least one of: a communications control channel; a communications broadcast channel; and a Bluetooth communications channel.

According to a eighth aspect of the application there is provided an apparatus comprising: input means for receiving at least one captured audio signal, each captured audio signal associated with a capture apparatus, wherein each captured audio signal comprises an indicator indicating whether a neighbouring capture apparatus was capturing the audio signal prior to the capture apparatus; and selector means for selecting at least one of the at least one captured audio signal.

The input means may further receive an audio signal request from a first position; and the selector means may further select the at least one of the at least one captured audio signal associated with the capture apparatus closest to the first position where the capture apparatus was capturing the audio signal prior to any other capture apparatus.

The selector means may comprise: an apparatus determiner for determining the capture apparatus closest to the first position; an awareness determiner means for determining the indicator indicates a neighbouring capture apparatus was capturing the audio signal prior to the capture apparatus; and a primary selector means for selecting the neighbouring capture apparatus.

An electronic device may comprise apparatus as described above.

A chipset may comprise apparatus as described above.

Embodiments of the present invention aim to address the above problems.

### SUMMARY OF THE FIGURES

For better understanding of the present application, reference will now be made by way of example to the accompanying drawings in which:

FIG. 1 shows schematically a multi-user free-viewpoint service sharing system which may encompass embodiments of the application;

FIG. 2 shows schematically an apparatus suitable for being employed in embodiments of the application;

FIG. 3 shows schematically an audio scene capturer according to some embodiments of the application;

FIG. 4 shows schematically a method of operation of the audio scene capturer shown in FIG. 3 according to some embodiments of the application;

FIG. 5 and FIG. 6 show schematic views of the operation of the audio scene awareness operation in further detail;

FIG. 7 shows schematically an example of a network configuration of audio scene capture apparatus according to some embodiments of the application;

FIG. 8 shows schematically the audio scene apparatus in further detail according to some embodiments of the application; and

FIG. 9 shows schematically the operations of the audio scene apparatus shown in FIG. 8 according to some embodiments of the application.

### EMBODIMENTS OF THE APPLICATION

The following describes in further detail suitable apparatus and possible mechanisms for the provision of effective synchronisation for audio. In the following examples audio signals and audio capture uploading and downloading is described. However it would be appreciated that in some embodiments the audio signal/audio capture, uploading and downloading is one part of an audio-video system.

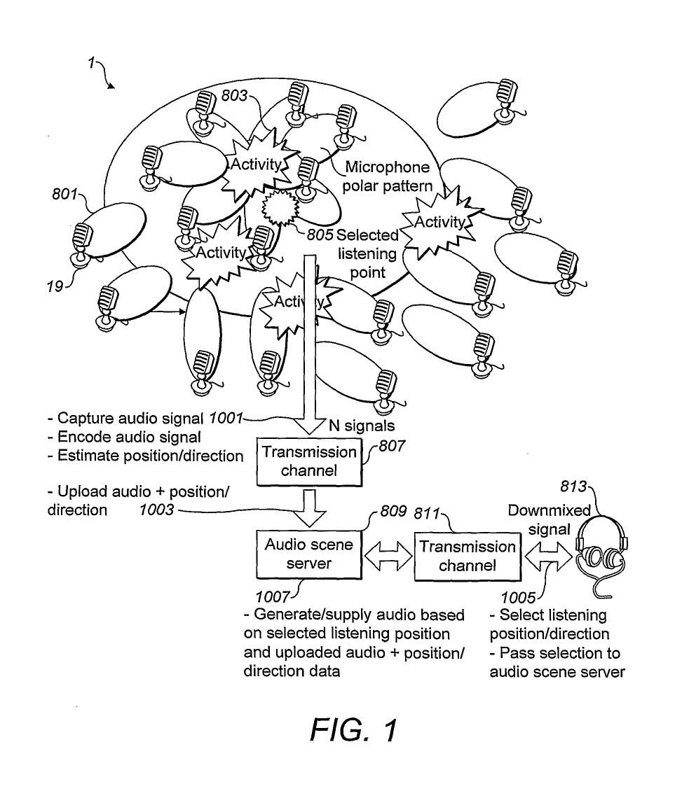

With respect to FIG. 1 an overview of a suitable system within which embodiments of the application can be located is shown. The audio space 1 can have located within it at least one recording or capturing devices or apparatus 10 which are arbitrarily positioned within the audio space to record suitable audio scenes. The apparatus shown in FIG. 1 are represented as microphones with a polar gain pattern 801 showing the directional audio capture gain associated with each apparatus. The apparatus 19 in FIG. 1 are shown such that some of the apparatus are capable of attempting to capture the audio scene or activity 803 within the audio space. The activity 803 can be any event the user of the apparatus wishes to capture. For example the event could be a music event or audio of a news worthy event. The apparatus 19 although being shown having a directional microphone gain pattern 801 would be appreciated that in some embodiments the microphone or microphone array of the recording apparatus 19 has a omnidirectional gain or different gain profile to that shown in FIG. 1.

Each recording apparatus 19 can in some embodiments transmit or alternatively store for later consumption the captured audio signals via a transmission channel 807 to an audio scene server 809. The recording apparatus 19 in some embodiments can encode the audio signal to compress the audio signal in a known way in order to reduce the bandwidth required in “uploading” the audio signal to the audio scene server 809.

The recording apparatus 19 in some embodiments can be configured to estimate and upload via the transmission channel 807 to the audio scene server 809 an estimation of the location and/or the orientation or direction of the apparatus. The position information can be obtained, for example, using GPS coordinates, cell-ID or a-GPS or any other suitable location estimation methods and the orientation/direction can be obtained, for example using a digital compass, accelerometer, or gyroscope information.

In some embodiments the recording apparatus 19 can be configured to capture or record one or more audio signals for example the apparatus in some embodiments have multiple microphones each configured to capture the audio signal from different directions. In such embodiments the recording device or apparatus 19 can record and provide more than one signal from different the direction/orientations and further supply position/direction information for each signal.

The capturing and encoding of the audio signal and the estimation of the position/direction of the apparatus is shown in FIG. 1 by step 1001.

The uploading of the audio and position/direction estimate to the audio scene server is shown in FIG. 1 by step 1003.

The audio scene server 809 furthermore can in some embodiments communicate via a further transmission channel 811 to a listening device 813.

In some embodiments the listening device 813, which is represented in FIG. 1 by a set of headphones, can prior to or during downloading via the further transmission channel 811 select a listening point, in other words select a position such as indicated in FIG. 1 by the selected listening point 805. In such embodiments the listening device 813 can communicate via the further transmission channel 811 to the audio scene server 809 the request.

The selection of a listening position by the listening device 813 is shown in FIG. 1 by step 1005.

The audio scene server 809 can as discussed above in some embodiments receive from each of the recording apparatus 19 an approximation or estimation of the location and/or direction of the recording apparatus 19. The audio scene server 809 can in some embodiments from the various captured audio signals from recording apparatus 19 produce a composite audio signal representing the desired listening position and the composite audio signal can be passed via the further transmission channel 811 to the listening device 813. In some embodiments the audio scene server 809 can be configured to select captured audio signals from the apparatus “closest” to the desired or selected listening point, and to transmit these to the listening device 813 via the further transmission channel 811.

The generation or supply of a suitable audio signal based on the selected listening position indicator is shown in FIG. 1 by step 1007.

In some embodiments the listening device 813 can request a multiple channel audio signal or a mono-channel audio signal. This request can in some embodiments be received by the audio scene server 809 which can generate the requested multiple channel data.

The audio scene server 809 in some embodiments can receive each uploaded audio signal and can keep track of the positions and the associated direction/orientation associated with each audio signal. In some embodiments the audio scene server 809 can provide a high level coordinate system which corresponds to locations where the uploaded/upstreamed content source is available to the listening device 813. The “high level” coordinates can be provided for example as a map to the listening device 813 for selection of the listening position. The listening device (end user or an application used by the end user) can in such embodiments be responsible for determining or selecting the listening position and sending this information to the audio scene server 807. The audio scene server 807 can in some embodiments receive the selection/determination and transmit the downmixed signal corresponding to the specified location to the listening device. In some embodiments the listening device/end user can be configured to select or determine other aspects of the desired audio signal, for example signal quality, number of channels of audio desired, etc. In some embodiments the audio scene server 807 can provide in some embodiments a selected set of downmixed signals which correspond to listening points neighbouring the desired location/direction and the listening device 813 selects the audio signal desired.

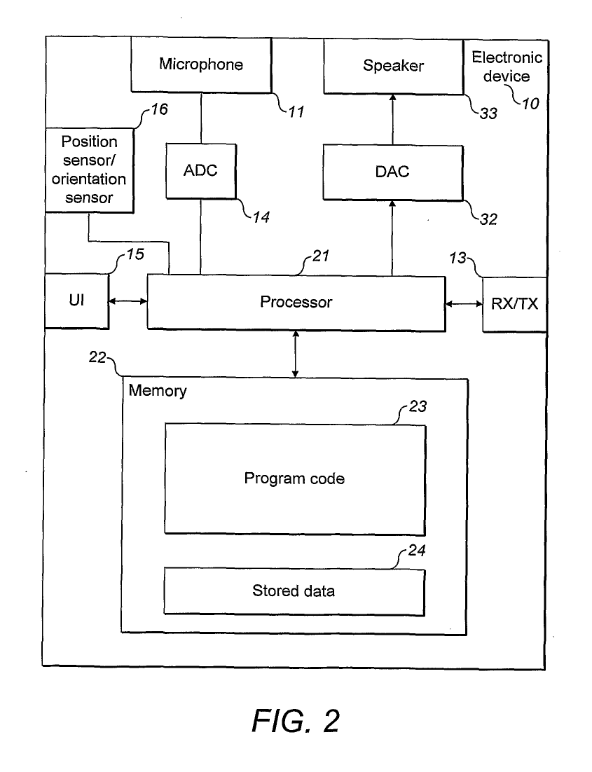

In this regard reference is first made to FIG. 2 which shows a schematic block diagram of an exemplary apparatus or electronic device 10, which may be used to record (or operate as a recording device 19) or listen (or operate as a listening device 813) to the audio signals (and similarly to record or view the audio-visual images and data).

The electronic device 10 may for example be a mobile terminal or user equipment of a wireless communication system.

In some embodiments the apparatus can be an audio player or audio recorder, such as an MP3 player, a media recorder/player (also known as an MP4 player), or any suitable portable device suitable for recording audio or audio/video camcorder/memory audio or video recorder.

The apparatus can in some embodiments comprise an audio subsystem. The audio subsystem for example can comprise in some embodiments a microphone or array of microphones 11 for audio signal capture. In some embodiments the microphone or array of microphones can be a solid state microphone, in other words capable of capturing audio signals and outputting a suitable digital format signal. In some other embodiments the microphone or array of microphones 11 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or microelectrical-mechanical system (MEMS) microphone. The microphone 11 or array of microphones can in some embodiments output the audio captured signal to an analogue-to-digital converter (ADC) 14.

In some embodiments the apparatus can further comprise an analogue-to-digital converter (ADC) 14 configured to receive the analogue captured audio signal from the microphones and outputting the audio captured signal in a suitable digital form. The analogue-to-digital converter 14 can be any suitable analogue-to-digital conversion or processing means.

In some embodiments the apparatus 10 audio subsystem further comprises a digital-to-analogue converter 32 for converting digital audio signals from a processor 21 to a suitable analogue format. The digital-to-analogue converter (DAC) or signal processing means 32 can in some embodiments be any suitable DAC technology.

Furthermore the audio subsystem can comprise in some embodiments a speaker 33. The speaker 33 can in some embodiments receive the output from the digital-to-analogue converter 32 and present the analogue audio signal to the user. In some embodiments the speaker 33 can be representative of a headset, for example a set of headphones, or cordless headphones.

Although the apparatus 10 is shown having both audio capture and audio presentation components, it would be understood that in some embodiments the apparatus 10 can comprise one or the other of the audio capture and audio presentation parts of the audio subsystem such that in some embodiments of the apparatus the microphone (for audio capture) or the speaker (for audio presentation) are present.

In some embodiments the apparatus 10 comprises a processor 21. The processor 21 is coupled to the audio subsystem and specifically in some examples the analogue-to-digital converter 14 for receiving digital signals representing audio signals from the microphone 11, and the digital-to-analogue converter (DAC) 12 configured to output processed digital audio signals. The processor 21 can be configured to execute various program codes. The implemented program codes can comprise for example audio encoding code routines.

In some embodiments the apparatus further comprises a memory 22. In some embodiments the processor is coupled to memory 22. The memory can be any suitable storage means. In some embodiments the memory 22 comprises a program code section 23 for storing program codes implementable upon the processor 21. Furthermore in some embodiments the memory 22 can further comprise a stored data section 24 for storing data, for example data that has been encoded in accordance with the application or data to be encoded via the application embodiments as described later. The implemented program code stored within the program code section 23, and the data stored within the stored data section 24 can be retrieved by the processor 21 whenever needed via the memory-processor coupling.

In some further embodiments the apparatus 10 can comprise a user interface 15. The user interface 15 can be coupled in some embodiments to the processor 21.

In some embodiments the processor can control the operation of the user interface and receive inputs from the user interface 15. In some embodiments the user interface 15 can enable a user to input commands to the electronic device or apparatus 10, for example via a keypad, and/or to obtain information from the apparatus 10, for example via a display which is part of the user interface 15. The user interface 15 can in some embodiments comprise a touch screen or touch interface capable of both enabling information to be entered to the apparatus 10 and further displaying information to the user of the apparatus 10.

In some embodiments the apparatus further comprises a transceiver 13, the transceiver in such embodiments can be coupled to the processor and configured to enable a communication with other apparatus or electronic devices, for example via a wireless communications network. The transceiver 13 or any suitable transceiver or transmitter and/or receiver means can in some embodiments be configured to communicate with other electronic devices or apparatus via a wire or wired coupling.

The coupling can, as shown in FIG. 1, be the transmission channel 807 (where the apparatus is functioning as the recording device 19) or further transmission channel 811 (where the device is functioning as the listening device 813). The transceiver 13 can communicate with further devices by any suitable known communications protocol, for example in some embodiments the transceiver 13 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

In some embodiments the apparatus comprises a position sensor 16 configured to estimate the position of the apparatus 10. The position sensor 16 can in some embodiments be a satellite positioning sensor such as a GPS (Global Positioning System), GLONASS or Galileo receiver.

In some embodiments the positioning sensor can be a cellular ID system or an assisted GPS system.

In some embodiments the apparatus 10 further comprises a direction or orientation sensor. The orientation/direction sensor can in some embodiments be an electronic compass, accelerometer, a gyroscope or be determined by the motion of the apparatus using the positioning estimate.

It is to be understood again that the structure of the electronic device 10 could be supplemented and varied in many ways.

Furthermore it could be understood that the above apparatus 10 in some embodiments can be operated as an audio scene server 809. In some further embodiments the audio scene server 809 can comprise a processor, memory and transceiver combination.

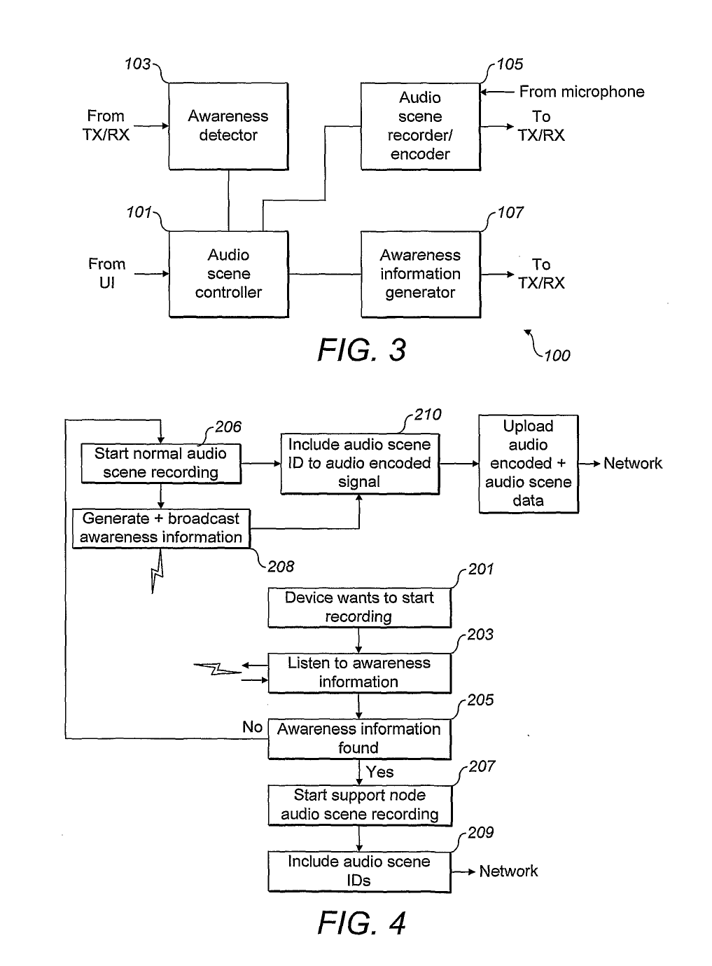

With respect to FIG. 3 the apparatus is shown in further detail with respect to audio scene capture embodiments of the application. The audio operations capture of the embodiments are furthermore shown with respect to FIG. 4.

The audio scene capture apparatus 100 can comprise in some embodiments an audio scene controller 101 or suitable controlling means. The audio scene controller 101 is configured to control the operation of the audio scene capture operations. The audio scene controller 101 is configured to determine whether high quality recording is already ongoing in a nearby location and provide the possibility of switching the audio scene capture apparatus 100 into a support node rather than a normal mode. The audio scene controller 101 further controls the operator of tagging the recording with the audio scene information that is being sent by the apparatus.

The audio scene controller 101 in some embodiments is configured to receive an input from the user equipment user interface 15 for initialising the recording or capture of the audio events surrounding the apparatus. In some other embodiments the audio scene controller 101 can initialise the recording after receiving a recording request message from an audio scene server.

The operation of initialising or start of the recording is shown in FIG. 4 by step 201.

The audio scene capture apparatus 100 further in some embodiments comprises an awareness detector 103. The awareness detector 103 is configured in some embodiments to receive inputs from the transceiver 13 to monitor for “awareness information”. The awareness detector 103 in some embodiments can examine a control channel of a communications system to determine whether any of the neighbouring apparatus are uploading audio to the server. In such embodiments the awareness detector 103 can examine the awareness information, which in some embodiments can comprise a location/direction estimate of the apparatus uploading awareness information on the control channel and/or audio encoded data on a broadcast/data channel of the communications system received by the transceiver 13.

The operation of listening to the awareness information by the awareness detector is shown in FIG. 4 by step 203.

The awareness detector 103 can pass the awareness information to the audio scene controller 101. The audio scene controller 101 in some embodiments can be configured to compare the awareness information with the current state of the apparatus 10. For example in some embodiments the audio scene controller 101 compares the current location/orientation of the apparatus which can be determined using the position/orientation sensor to the estimated location of the “detected” apparatus recording and uploading.

In some embodiments the audio scene controller 101 compares the current and detected apparatus by determining a “distance” between the current apparatus and detected apparatus. The “distance” in some embodiments is the mean squared error between the current apparatus location/direction and the detected apparatus location/direction. Furthermore the audio scene controller 101 can determine that awareness information has been “found” where the “distance” is less than a predetermined “threshold value”, in other words the audio scene controller determines that detected apparatus awareness is relevant to the current apparatus. In some embodiments where the audio scene controller 101 determines that the “distance” between the current apparatus and the detected apparatus is greater than a predetermined threshold or that no awareness information has been determined by the awareness detector 103, a decision that no awareness information has been determined can be made.

The operation of determining whether or not awareness information has been determined (or that the detected awareness information indicates that the distance between the current apparatus and the uploading “detecting” apparatus is short enough) is shown in FIG. 4 by step 205.

Where the awareness information has been found, the operation shown in FIG. 4 passes to step 207 in other words the audio scene controller 101 is configured to control the audio scene capture apparatus 100 to operate in a support mode. However where there is no awareness information found, or the detected apparatus is not relevant as it is too far or distant from the current apparatus the audio scene controller 101 is configured to control the audio scene capture apparatus 100 to operate in a normal mode and the operation shown in FIG. 4 passes to step 206.

The audio scene controller 101 in some embodiments after determining that no awareness information has been found (or the distance is greater than the predetermined threshold value), can be configured to instruct or operate the audio scene recorder/encoder 105 to operate in a “normal” or primary node audio scene recording mode. For example the audio scene controller can pass a “normal” mode message or taken to the audio scene recorder/encoder 105.

In some embodiments the audio capture apparatus 100 further comprises an audio scene recorder/encoder 105 configured to receive the digital audio signals from the microphone and analogue-to-digital converter combination and encode the audio signals. The audio scene recorder/encoder 105 can in some embodiments encode the received audio signal in a “normal” mode encoding prior to uploading in a “normal” mode having received a “normal” mode indicator from the audio scene controller 101. The “normal” encoding mode for the audio signal can be in any suitable encoding mechanism and can for example be a high bit rate encoding to ensure a high quality signal. The high quality encoding can for example in some embodiments be based on but not limited to coding schemes such as MP3, AAC, EAAC+, AMR-WV+, ITU G.718 and its annexes. For example in some embodiments the audio scene recorder/encoder 105 can be configured to in the normal audio scene recording mode to record and encode at 128 kilobits per second using an AAC encoding.

The operation of normal audio scene recording and encoding is shown in FIG. 4 by step 206.

The audio capture apparatus further comprises an awareness information generator 107. The awareness information generator 107 is configured to, when receiving instructions (or messages or indications) from the audio scene controller 101 that there is no other uploading apparatus within the predetermined distance threshold in other words to operate in a “normal” mode, is configured to generate awareness information associated with the audio recording/encoding operation. The awareness information generator 107 can in some embodiments generate information such as an audio scene identifier which can be an identification value identifying the “normal” mode scene recording and encoding being carried out by the current apparatus.

The audio scene identifier in some embodiments can be derived, using a current (such as the calendar/system) time of the apparatus in milliseconds or microseconds. In such embodiments the likelihood that the same time identification value is derived by a further apparatus in some other location is negligible. However in some further embodiments the awareness information generator can generate the audio scene identification value based on the time and also the current estimated location and/or orientation. This can be derived for example from the GPS position using information from the position sensor/orientation sensor 16 (or last known position if the current position cannot be acquired for some reason) to the recordings.

In some embodiments the audio awareness information generator 107 can generate an identification value using information such as the capture apparatus 19 mobile phone number, the Bluetooth ID value associated with the capture apparatus, the media access controller (MAC) address of the capture apparatus 19, or the international mobile equipment identity (IMEI) code of the capture apparatus.

In some further embodiments the audio awareness information generator 107 can acquire the audio scene identifier from a server which monitors and keeps track of the identification values reserved for various audio scenes.

In some other embodiments the awareness information generator 107 can further be configured to generate information determining the range over which the audio identification value is broadcasted with respect to the sending or uploading device 10.

The awareness information generator 107 range information can express the distance, for example in metres, allowing a proximity aspect to the awareness information such that the size of the audio scene can be limited to a meaningful size (such as a maximum of 5 metres with respect to the location of the apparatus recording the audio scene).

In some embodiments the awareness information generator 107 can furthermore pass the awareness information to the transceiver 13 for uploading over the transmission channel to the audio scene server, for example on a control channel when the transceiver outputs the encoded audio signal over the data channel/broadcast channel. In some further embodiments the awareness information can be uploaded or broadcast on a separate system to that of the uploading of the audio information. For example the audio scene identifier can be broadcast on a Bluetooth local wireless communication link as well as or instead of awareness information and the audio encoding on a cellular UMTS link.

The operation of generating and uploading/broadcasting the awareness information is shown in FIG. 4 by step 208.

The operation of broadcasting/uploading the audio scene recording and audio scene identification values to the network is also shown in FIG. 4 by step 211.

The audio scene controller 101 in some embodiments after determining that there is awareness information can instruct the audio scene recorder/encoder 105 and the awareness information generator 107 to operate in a “support” mode of operation.

The audio scene recorder/encoder 105 in a support mode can be configured such that the bit rate of encoding is smaller than the high quality recording. For example in some embodiments if the variable BR_support is the bit rate of the support mode device and BR_HQ is the bit rate of the normal recording then BR_support is less than BR_HQ. The support mode recording can for example be achieved in some embodiments using low bit rate versions of the coding schemes defined for the high quality encoding. For example the audio scene encoder 105 can in some embodiments in the support mode record the audio signal using a 16 kilobits AAC encoding.

In some embodiments the audio scene encoder 105 can be furthermore be passed or be supplied with information concerning the detected normal mode encoding and as such can selectively encode a specific frequency range of the audio scene that is relevant in order to permit multichannel audio signals to be reconstructed. For example it is known that low frequency audio is generally uniform in nature whereas the higher frequency components are usually more directionally variable.

The operation of starting the support node audio scene recording is shown in FIG. 4 by step 207.

Furthermore the awareness information generator 107 can be configured in the support mode to generate an audio scene awareness information block featuring support mode awareness information. In such embodiments the awareness information generator is configured to output the original audio scene identification value and also a support node identification value. The support mode identifier/identification value can in some embodiments be determined in the same manner as the normal mode. In some other embodiments the support mode identifier can be generated using a value dependent on the detected “normal mode” identifier/identification value. Thus the apparatus can generate and upload/broadcast awareness information and audio data in a format such as:

Element 1 Element 2 Element 3 Element 4

The awareness information generator 107 and audio scene recorder/encoder 105 can be configured to format the output of the transceiver to output Element 1 of the message as the recorded and encoded audio scene from the apparatus operating in support mode, Element 2 as a flag component indicating whether or not the encoded stream is a support mode, Element 3 as the primary or detected apparatus audio scene identification value, and the Element 4 component is an associated or support mode identification value. The encoded audio scene element in such embodiments therefore indicates whether or not the uploaded signal is in a normal or support node mode from the support node flag element.

In some embodiments the determination of whether or not the received audio scene format data is a support node or not can be found directly from the Element 4 information indicating whether or not there is an associated identification value, in other words where there is no associated identification value the uploaded message is a normal mode message and where there is associated identification values, the message is a support mode message. In some embodiments the message format can be configured such that where the apparatus is used in the support mode the Element 2 component is left null or void. Furthermore in some embodiments where multiple awareness information values are found, Element 4 can detail multiple support nodes.

The operation of including the audio scene identification values for a support mode in a message on the network can be seen in FIG. 4 by step 209.

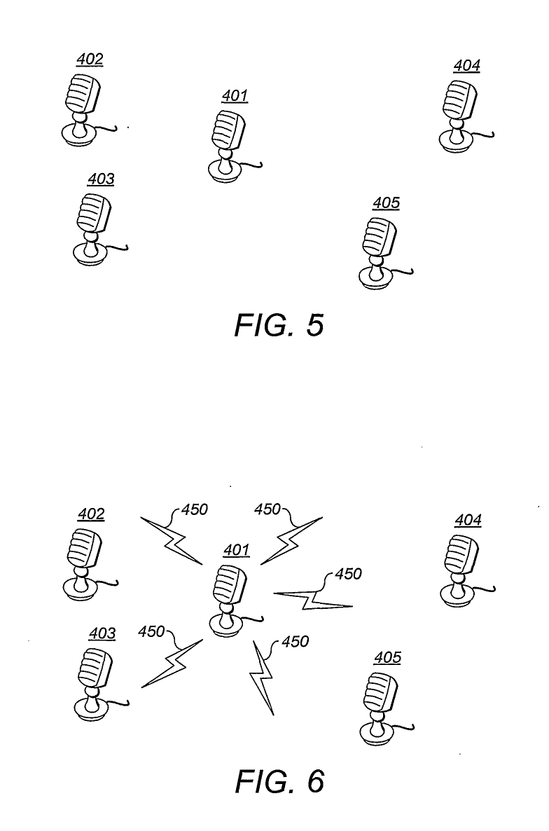

With respect to FIGS. 5 and 6 the operation of embodiments of the application with respect to the broadcasting the “normal mode” identification values can be seen. With respect to FIG. 5, five separate apparatus are shown, a first apparatus 401, a second apparatus 402, a third apparatus 403, a fourth apparatus 404, and a fifth apparatus 405. With respect to FIG. 6 the first apparatus 401 is initialised to start encoding and capturing audio. On determining that no other apparatus has within the range of detection of the first apparatus 401 can start to record or encode the audio signal and the first apparatus broadcasts activity information shown by the label 450 within the neighbouring area. Thus if apparatus 402 were to attempt to start to record and upload information it would determine or detect activity information and be configured to operate in a support mode of operation.

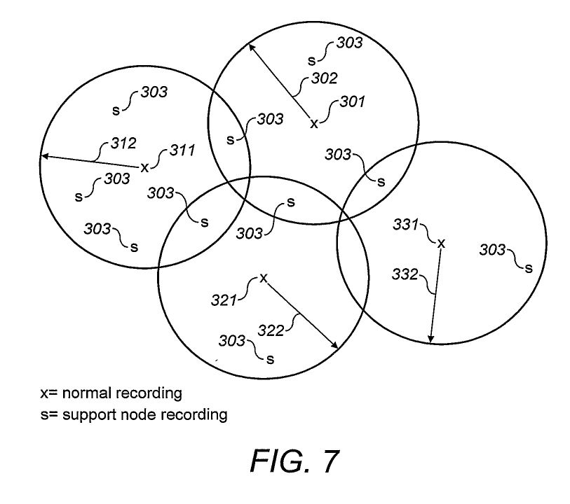

Furthermore with respect to FIG. 7, a further example is shown whereby apparatus 301 defines a range 302 within which any further apparatus such as apparatus 303 operate in a support mode of operation. Furthermore outside the range of operation defined by the first apparatus 301 range 302 there are a second normal mode apparatus 331, a third normal mode apparatus 321, and a fourth normal mode apparatus 311 which have associated a second range 332, a third range 322, and a fourth range 312 respectively within which any further apparatus operate within the support mode.

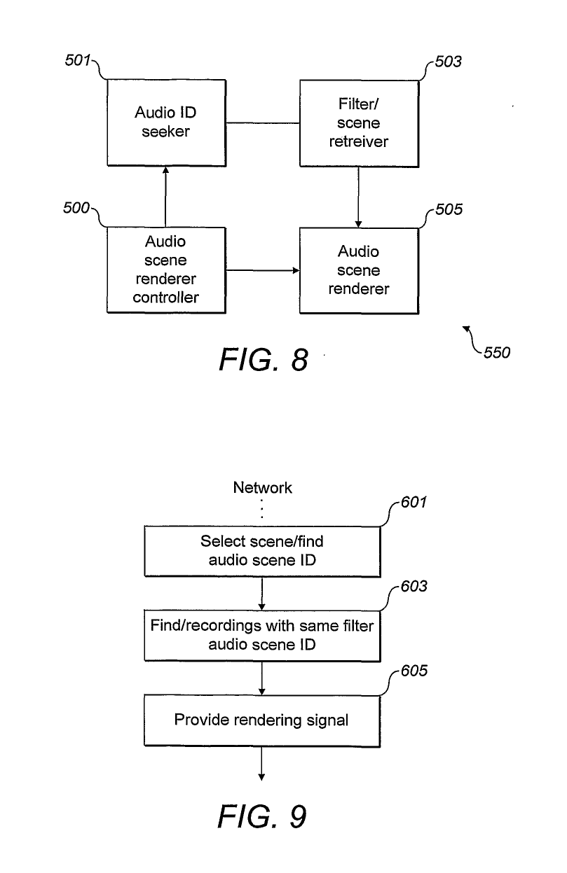

With respect to FIGS. 8 and 9 the audio scene server apparatus is shown in further detail together with of the operation of the audio scene server apparatus according to some embodiments of the application. The audio scene server can comprise rendering apparatus 550 which can comprise an audio scene renderer controller 500 configured to receive the audio recordings from the recorder/encoder apparatus 19 and control the rendering carried out in such a way that it is possible to pass the audio signal to a further apparatus the listening apparatus 813 in order that it may be output to the end user.

The audio scene renderer controller 500 for example in some embodiments is configured to receive an indicator as discussed previously from the further network determining a desired listening location/orientation. In some embodiments the available listening location/orientation selection is limited to the list of location/orientation of available recordings, however in some further embodiments the desired listening position/orientation can be chosen from any listening location/orientation. The audio scene renderer controller 500 in such embodiments can receive a requested or desired location/orientation and search the available recordings dependent upon the GPS or relevant positional information associated with each recording. In some embodiments the audio scene renderer controller 500 can pass the desired location/orientation to an audio ID seeker 501.

In some embodiments the rendering apparatus can comprise an audio ID seeker 501. The audio ID seeker 501 can be configured to find the audio ID value associated with the recording closest to the required location. The audio ID seeker 501 can in some embodiments output a list of the audio ID values with recordings close to the required location of the audio signal. This definition of “close” can in some embodiments be an error function of the distance between the desired location/orientation and the available recordings location/orientation.

The selection of the scene/finding the audio scene identification value is shown in FIG. 9 by step 601.

In some embodiments the rendering apparatus 550 further comprises a filter/scene retriever 503. The filter 503 is configured to receive the audio ID values neighbouring the desired location and determine the “normal mode” audio scene recording associated with the audio signal location values. The associated recording can then be output to the audio scene renderer 505. Furthermore in some embodiments associated support node mode recordings neighbouring the desired listening location can also be passed to the audio scene renderer 505.

In some embodiments the audio renderer 505 can comprise an audio scene renderer 505 configured to receive the output of the filter 503 and the associated normal and support node recordings. The audio scene renderer 505 is then configured in some embodiments to render the audio signals to produce the required number of channels and mixing for the position. The audio scene renderer can be any suitable means for rendering or mixing including beamforming, downmixing, upmixing and any other suitable audio processing of the normal and support node mode recordings.

In some embodiments the broadcast message containing broadcast awareness information can comprise a message of the type

1. Message Title: “Audio scene recording”

2. Audio Scene ID: 123456789

3. Physical Range: 5 (metres)

In such a broadcast message format the first line can define the title of the message, the second line can identify the identification value of the audio scene, and the third line would specify the broadcast range or effective awareness detection range which could be used to define the threshold value. It would be understood that the above message format is an example of a suitable message and the format can be changed or altered. In such embodiments the support mode recorder awareness detector can in some embodiments search for a message which is titled according to the first line where a message such as that is found the identification value would be attached to the support mode recording as described above. The support mode recording would then also monitor the awareness channel regularly and every time it determines a new message the audio scene identification value of that message would be also or instead attached to the recording.

Thus in at least one of the embodiments there can be an apparatus comprising: determiner means for determining whether a further apparatus is capturing an audio signal neighbouring the apparatus; controller means for determine a capture characteristic based on whether the further apparatus is capturing an audio signal neighbouring the apparatus; and recording means for capturing the audio signal based on the capture characteristic.

Therefore in at least one embodiments there is provided there is provided an apparatus comprising: input means for receiving at least one captured audio signal, each captured audio signal associated with a capture apparatus, wherein each captured audio signal comprises an indicator indicating whether a neighbouring capture apparatus was capturing the audio signal prior to the capture apparatus; and selector means for selecting at least one of the at least one captured audio signal.

Although the above has been described with regards to audio signals, or audio-visual signals it would be appreciated that embodiments may also be applied to audio-video signals where the audio signal components of the recorded data are processed in terms of the determining of the base signal and the determination of the time alignment factors for the remaining signals and the video signal components may be synchronised using the above embodiments of the invention. In other words the video parts may be synchronised using the audio synchronisation information.

It shall be appreciated that the term user equipment is intended to cover any suitable type of wireless user equipment, such as mobile telephones, portable data processing devices or portable web browsers.

Furthermore elements of a public land mobile network (PLMN) may also comprise apparatus as described above.

In general, the various embodiments of the invention may be implemented in hardware or special purpose circuits, software, logic or any combination thereof.

For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. Apparatus comprising at least one processor and at least one memory including computer code, the at least one memory and the computer code configured to with the at least one processor cause the apparatus to:
determine whether a further apparatus is capturing an audio signal neighbouring the apparatus;
determine a capture characteristic based on whether the further apparatus is capturing an audio signal neighbouring the apparatus; and
capture the audio signal based on the capture characteristic.

2. The apparatus as claimed in claim 1, wherein the at least one memory and the computer code are configured with the at least one processor to cause the apparatus to determine whether a further apparatus is capturing an audio signal neighbouring the apparatus further causes the apparatus to determine whether an awareness indicator has been received from the further apparatus.

3. The apparatus as claimed in claim 2, wherein the awareness indicator comprises at least one of:
a further apparatus identifier value;
a further apparatus capture characteristic value; and
a defined distance value.

4. The apparatus as claimed in claim 2, wherein the at least one memory and the computer code are configured with the at least one processor to cause the apparatus to determine whether a further apparatus is capturing an audio signal neighbouring the apparatus further causes the apparatus to perform:
determine the distance between the apparatus and the further apparatus; and
determine the further apparatus is neighbouring the apparatus when the distance is less than a defined value.

5. The apparatus as claimed in claim 1, wherein the capture characteristic comprises at least one of:
capture encoding algorithm;
capture encoding rate; and
capture frequency response.

6. The apparatus as claimed in claim 1, wherein the at least one memory and the computer code are configured with the at least one processor to further cause the apparatus to generate an awareness indicator comprising at least one of:
an identifier indicator of the apparatus;
an identifier indicator of the further apparatus;
an indicator of the capture characteristic of the apparatus; and
a defined distance value for the apparatus.

7. The apparatus as claimed in claim 6, wherein the at least one memory and the computer code are configured with the at least one processor to further cause the apparatus to:
output at least the captured audio signal on a first communications channel; and
output the awareness indicator on a second communications channel.

8. The apparatus as claimed in claim 7, wherein the at least one memory and the computer code are configured with the at least one processor to further cause the apparatus to output the awareness indicator on the first communications channel.

9. The apparatus as claimed in claim 7, wherein the first communications channel comprises a communications data channel, and wherein the second communications channel comprises at least one of:
a communications control channel;
a communications broadcast channel; and
a Bluetooth communications channel.

10. (canceled)

11. A method comprising:
determining whether a further apparatus is capturing an audio signal neighbouring the apparatus;
determining a capture characteristic based on whether the further apparatus is capturing an audio signal neighbouring the apparatus; and
capturing the audio signal based on the capture characteristic.

12. The method as claimed in claim 11, wherein determining whether a further apparatus is capturing an audio signal neighbouring the apparatus further comprises determining whether an awareness indicator has been received from the further apparatus.

13. The method as claimed in claim 12, wherein the awareness indicator comprises at least one of:
a further apparatus identifier value;
a further apparatus capture characteristic value; and
a defined distance value.

14. The method as claimed in claim 12, wherein determining whether a further apparatus is capturing an audio signal neighbouring the apparatus further comprises:
determining the distance between the apparatus and the further apparatus; and
determining the further apparatus is neighbouring the apparatus when the distance is less than a defined value.

15. The method as claimed in claim 11, wherein the capture characteristic comprises at least one of:
capture encoding algorithm;
capture encoding rate; and
capture frequency response.

16. The method as claimed in claim 11, further comprising generating an awareness indicator comprising at least one of:
an identifier indicator of the apparatus;
an identifier indicator of the further apparatus;
an indicator of the capture characteristic of the apparatus; and
a defined distance value for the apparatus.

17. The method as claimed in claim 16, further comprising:
outputting at least the captured audio signal on a first communications channel; and
outputting the awareness indicator on a second communications channel.

18. The method as claimed in claim 17, further comprising outputting the awareness indicator on the first communications channel.

19. The method as claimed in claim 17, wherein the first communications channel comprises a communications data channel, and wherein the second communications channel comprises at least one of:
a communications control channel;
a communications broadcast channel; and
a Bluetooth communications channel.

20. (canceled)

21. Apparatus comprising at least one processor and at least one memory including computer code, the at least one memory and the computer code configured to with the at least one processor cause the apparatus to:
receive at least one captured audio signal, each captured audio signal associated with a capture apparatus, wherein each captured audio signal comprises an indicator indicating whether a neighbouring capture apparatus was capturing the audio signal prior to the capture apparatus; and
select at least one of the at least one captured audio signal.

22. The apparatus as claimed in claim 21, wherein the at least one memory and the computer code are configured with the at least one processor to further cause the apparatus to:
receive an audio signal request from a first position; and wherein the at least one memory and the computer code are configured with the at least one processor to cause the apparatus to select the at least one of the at least one captured audio signal causing the apparatus to select the at least one of the at least one captured audio signal associated with the capture apparatus closest to the first position where the capture apparatus was capturing the audio signal prior to any other capture apparatus.

23. The apparatus as claimed in claim 22, wherein the at least one memory and the computer code are configured with the at least one processor to further cause the apparatus to select the at least one of the at least one captured audio signal associated with the capture apparatus closest to the first position where the capture apparatus was capturing the audio signal prior to any other capture apparatus to causes the apparatus to:
determine the capture apparatus closest to the first position;
determine the indicator indicates a neighbouring capture apparatus was capturing the audio signal prior to the capture apparatus; and
select the neighbouring capture apparatus.

24. A method comprising:
receiving at least one captured audio signal, each captured audio signal associated with a capture apparatus, wherein each captured audio signal comprises an indicator indicating whether a neighbouring capture apparatus was capturing the audio signal prior to the capture apparatus; and
selecting at least one of the at least one captured audio signal.

25. The method as claimed in claim 24, further comprising receiving an audio signal request from a first position; and wherein selecting the at least one of the at least one captured audio signal further comprises selecting the at least one of the at least one captured audio signal associated with the capture apparatus closest to the first position where the capture apparatus was capturing the audio signal prior to any other capture apparatus.

26. The method as claimed in claim 25, wherein selecting the at least one of the at least one captured audio signal associated with the capture apparatus closest to the first position where the capture apparatus was capturing the audio signal prior to any other capture apparatus comprises:
determining the capture apparatus closest to the first position;
determining the indicator indicates a neighbouring capture apparatus was capturing the audio signal prior to the capture apparatus; and
selecting the neighbouring capture apparatus.

27-28. (canceled)
